(19) United States
(12) Patent Application Publication
(10) Pub. No.: US 2006/0175517 A1
(43) Pub. Date: Aug. 10, 2006

(54) Auto full forward seat adjuster

(76) Inventors: Glenn F. Syrowik, Ortonville, MI (US); Ravi Hosalli, Troy, MI (US); Peter Paul Zeimis III, Shelby Township, MI (US); Frank T. Eupizi, Macomb Twp., MI (US); John Forrest Oilar, Novi, MI (US); Ronald J. Kaip, Sterling Heights, MI (US); Joseph Charles Montano, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/056,931

(22) Filed: Feb. 10, 2005

(51) Int. Cl. A47C 1/02; F16M 13/00

(52) U.S. Cl. 248/424

(57) ABSTRACT

An auto full forward seat adjuster assembly and a method and system for seat adjustment. The assembly includes a seat slidably engaged with a seat track, an activation device, and a seat track release member. The activation device positions the seat track release member to allow slidable movement of the seat as the seat is pivoted forward, automatically bringing the seat to a forward position.

### TECHNICAL FIELD OF THE INVENTION

The present invention relates generally to folding vehicle seat assemblies. More particularly, the invention relates to an assembly, method, and system providing sliding movement in conjunction with a folding seat in a vehicle.

### BACKGROUND OF THE INVENTION

Conventional vehicle folding seat assemblies provide for the mechanical folding operation of a seat back between a seat position and a collapsed position for stowing. Often times it is necessary to provide at least a secondary action from a user of the vehicle in order to ready the seat assembly for stowing. For example, a user may be required to activate a seat release, and bring a seat to its most forward position prior to stowing. This makes the seat assembly difficult to use and less attractive to the user.

It would be desirable to provide a seat assembly that automatically brings a seat forward into its stowing position.

### SUMMARY OF THE INVENTION

A first aspect of the present invention provides a seating assembly for a vehicle. The assembly includes a seat slidably engaged with a seat track, an activation device, and a seat track release member. The activation device positions the seat track release member to allow slidable movement of the seat as the seat is pivoted forward, automatically bringing the seat to a forward position.

A second aspect of the invention provides a method for positioning a seat in a vehicle. The method includes pivoting the seat toward a stow position, releasing engagement of the seat with a seat track in response to the pivoting, and allowing the seat to slide automatically to a forward position in the seat track.

A third aspect of the invention provides a seat assembly for a vehicle. The assembly includes a seat slidably engaged with a seat track, means for pivoting the seat toward a stow position, means for releasing engagement of the seat with the seat track operably connected to the pivoting means, means for activating the releasing means, and means for allowing the seat to slide automatically to a forward position in the seat track when the activating means activates the releasing means.

The foregoing and other features and advantages of the invention will become further apparent from the following detailed description of the presently preferred embodiments, read in conjunction with the accompanying drawings. The figures are not drawn to scale. The detailed description and drawings are merely illustrative of the invention, rather than limiting the scope of the invention being defined by the appended claims and equivalents thereof.

### BRIEF DESCRIPTION OF THE DRAWINGS

FIG. 1 is a perspective view of a left seat version of a seat assembly in accordance with one embodiment of the present invention;

FIGS. 2 is a front elevated view of right seat version of the seat assembly shown in FIG. 1;

FIG. 3 illustrates an enlarged view of an activation device of the seat assembly shown in area A of FIG. 2;

FIG. 4 illustrates an enlarged view of a pulley system of the seat assembly shown in area B of FIG. 2; and

FIG. 5 illustrates an enlarged view of an extension spring of the seat assembly shown in area C of FIG. 2;

### DESCRIPTION OF THE PRESENTLY PREFERRED EMBODIMENTS

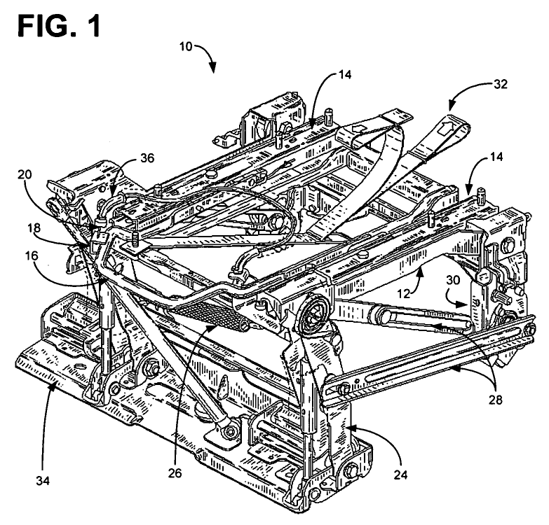

Referring to the drawings, wherein like reference numerals refer to like elements, FIGS. 1-5 are alternative views of various portions of a seat assembly in accordance with one embodiment of the present invention. The assembly is shown generally by numeral 10. Assembly 10 includes a seat base 14 with seat tracks 12 and release member 16. Applying force to release member 16 disengages seat base 14, for example by releasing a brake, latch, or the like, allowing a seat (not shown) to slide along seat track 12, for example forward and backward.

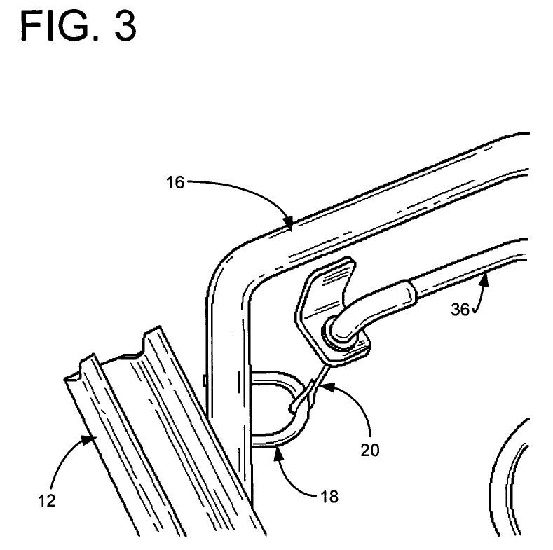

Also referring to FIG. 3, assembly 10 includes activation device 18 that provides an alternate device for disengaging seat base 14, allowing the seat to slide on seat track 12. In one embodiment, activation device 18 may act upon release member 16 to disengage seat base 14. Alternatively, activation device 18 may act singularly to disengage seat base 14, for example by releasing a latch or brake on seat track 12. In one embodiment, release member 16 may be a release bar, as known in the art. Lifting release bar 16 disengages seat base 14. Activation device 18 may include release cable 20 connected to release bar 16 and to some other part of seat assembly 10. Release cable 20 may be encased for some or all of its length by cable encasing 36.

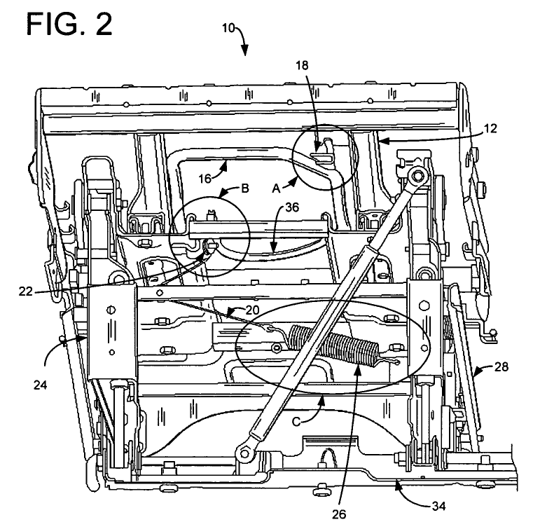

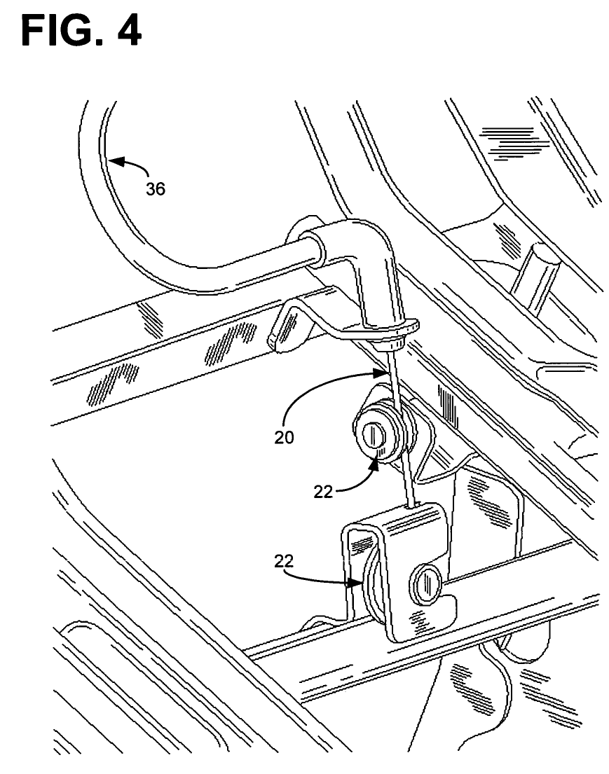

Further referring to FIG. 4, which illustrates an enlarged view of a pulley system of the seat assembly shown in area B of FIG. 2, release cable 20 may run over one or more pulleys 22. The one or more pulleys 22 may provide directional change for release cable 20. Alternatively or in addition to directional change, compound pulleys 22 may be used for leverage to increase or decrease the force required to disengage seat base 14. Using compound pulleys 22, a movement of cable 20 may be translated into a stronger pull over a shorter distance, as known in the art.

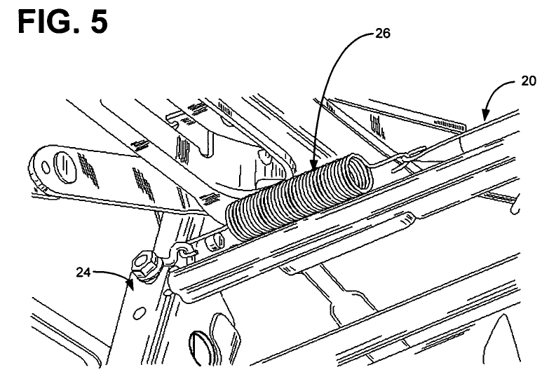

Further referring to FIG. 5, which illustrates an enlarged view of an extension spring of the seat assembly shown in area C of FIG. 2, release cable 20 may be attached to one or more extension springs 26. Release cable 20, and the one or more extension springs 26 may be metal, elastic, plastic, or any other material as known in the art. In the embodiment shown., release cable 20 and extension spring 26 are attached to forward seat legs 24. The release cable 20 may alternatively be connected to other parts of seat assembly 10 and still maintain its function. In one embodiment, extension spring 26 may be included to provide resistance to a pull on release cable 20. Alternatively, extension spring 26 may provide flexibility in the distance over which release cable 20 and extension spring 26 may cover.

Further included in assembly 10 are folding mechanism 28, rear seat legs 30, stow belt 32, and vehicle mount 34. When a vehicle user begins the stowing process by pulling stow belt 32, rear seat legs 30 are disengaged from the vehicle, and the back of the seat is able to be raised by further pulling on the belt or by lifting on the seat bottom. Folding mechanism 28 allows rear seat legs 30 to be folded inward as the rear of seat base 14 is raised, and seat base 14 is rotated forward. In one embodiment, rotational movement of the seat base 14 is translated to a force via activation device 18 to activate release member 16, disengaging seat base 14. As seat base 14 is rotated forward, the relative distance of parts of seat base 14 with respect to forward seat legs 22 increases. As this distance increases, release cable 20 is pulled, and activation device 18 disengages seat base 14. In one embodiment, activation device 18 attaches release cable 20 to release member 16, and pulling release cable 20 results in a pull or lift on release member 16 thereby disengaging seat base 14.

In an exemplary embodiment, as seat base 14 is rotated forward the angle of the seat base 14 with respect to the vehicle increases. As this angle increases, and once the seat base 14 is disengaged, the force of gravity acting on the weight may pull the seat forward. In this way, the seat is brought to a full forward position during the stow process without additional steps by the vehicle user.

While the embodiments of the invention disclosed herein are presently considered to be preferred, various changes and modifications can be made without departing from the spirit and scope of the invention. The auto full forward seat adjuster and method are not limited to any particular design or arrangement.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

What is claimed is:

1. A seat assembly for a vehicle comprising:
a seat slidably engaged with a seat track;
an activation device; and
a seat track release member, wherein the activation device positions the seat track release member to allow slidable movement of the seat as the seat is pivoted forward, automatically bringing the seat to a forward position.

2. The assembly of claim 1, wherein the activation device is a pulling release cable.

3. The assembly of claim 2, wherein the pulling release cable is routed through a pulley system.

4. The assembly of claim 2, wherein the pulling release cable is attached to an extension spring.

5. The assembly of claim 1, wherein the release member is a release bar.

6. The assembly of claim 5, wherein the release bar is raised to allow the seat to slide on the track.

7. The assembly of claim 5, wherein the activation device raises the release bar.

8. The assembly of claim 1, wherein the movement of the seat is rotational movement.

9. A method for positioning a seat within a vehicle, the method comprising:
pivoting the seat toward a stow position;
releasing engagement of the seat with a seat track in response to the pivoting; and
allowing the seat to slide automatically to a forward position in the seat track.

10. The method of claim 9, wherein the pivoting is a rotational movement.

11. The method of claim 9, wherein the releasing comprises positioning a seat track release member with an activation device.

12. The method of claim 1 1, wherein the activation device is a pulling release cable.

13. The method of claim 1 1, wherein the release member is a release bar.

14. The method of claim 13, wherein the releasing comprises raising the release bar.

15. The method of claim 11, further comprising adjusting a force applied in the releasing with a device selected from the group consisting of pulleys and extension springs.

16. The method of claim 9, wherein the allowing comprises allowing the seat to slide to the forward position due to gravitational forces.

17. A seat assembly for a vehicle comprising:
a seat slidably engaged with a seat track;
means for pivoting the seat toward a stow position;
means for releasing engagement of the seat with the seat track operably connected to the pivoting means;
means for activating the releasing means; and
means for allowing the seat to slide automatically to a forward position in the seat track when the activating means activates the releasing means.

18. The assembly of claim 17, wherein the activating means comprises means for adjusting force applied to the releasing means.

19. The assembly of claim 17, wherein the activating means is a pulling release cable.

20. The assembly of claim 17, wherein the releasing means is a release bar.
